(19) United States
(12) Patent Application Publication
(10) Pub. No.: US 2016/0078842 A1
(43) Pub. Date: Mar. 17, 2016

(54) UNIVERSAL DIGITAL CONTROLLER DESIGN FOR DC/DC SWITCHING POWER SUPPLIES USED IN DISPLAYS

(71) Applicant: Pixtronix, Inc., San Diego, CA (US)

(72) Inventors: Didier Henri Farenc, San Diego, CA (US); Paul Penchin Pan, San Diego, CA (US)

(21) Appl. No.: 14/726,176

(22) Filed: May 29, 2015

Related U.S. Application Data
(60) Provisional application No. 62/048,996, filed on Sep. 11, 2014.

(51) Int. Cl. G09G 5/00

(52) U.S. Cl. CPC G09G 5/006; G09G 2330/025

(57) ABSTRACT

This disclosure provides systems, methods and apparatus for a power supply module capable of providing power to a display apparatus. In one aspect, the power supply module can include a power supply controller that is capable executing commutation cycles, where each commutation cycle includes energizing an inductor for a first time period and then allowing the energized inductor to supply power to the display apparatus for a second time period. The power supply module can operate in active-high and active-low states, in which the power supply module executes commutation cycles, and a suspend state, in which no commutation cycles are executed. The power supply module transitions between these states based in part on the value of the output voltage. A peak current value is varied such that that the power supply module converges to operating in the active-high and active-low states after peak current demand is met.

### CROSS-REFERENCE TO RELATED APPLICATIONS

This patent application claims priority to U.S. Provisional Patent Application No. 62/048,996 entitled “UNIVERSAL DIGITAL CONTROLLER DESIGN FOR DC/DC SWITCHING POWER SUPPLIES USED IN DISPLAYS,” filed Sep. 11, 2014, assigned to the assignee hereof and hereby expressly incorporated by reference herein.

### TECHNICAL FIELD

This disclosure relates to the field of displays, an in particular, to display power supply controllers.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus including a switching circuit, a voltage sensor and a digital controller. The switching circuit is coupled to an inductor, a capacitor and a display device connected in parallel to the capacitor, and is configured to perform a plurality of commutation cycles to provide an output current, where an average value of the output current during a commutation cycle is in part a function of a peak inductor current value. The voltage sensor is configured to compare a voltage across the capacitor to a target voltage value. The digital controller, is coupled to the switching circuit and to the voltage sensor, and is configured to receive the target voltage. The digital controller is further configured to selectively operate in at least one of a first state for a first time period, a second state for a second time period, and a third state for a third time period, where operating in the first state includes performing the plurality of commutation cycles to generate a first average value of the output current, operating in the second state includes performing the plurality of commutation cycles to generate a second average value of the output current, and operating in the third state results in maintaining a substantially zero average value of the output current. The digital controller is also configured to, for the received target voltage, dynamically adjust the peak current value such that the third time period diminishes over a plurality of iterations through the first, second, and third states, and the voltage across the capacitor converges towards the target voltage.

In some implementations, each commutation cycle includes selectively energizing the inductor and selectively allowing the inductor to provide the output current to the capacitor and to the display device. In some implementations, the digital controller is further configured to diminish the third time period to substantially zero over the plurality of iterations through the first state, second state, and the third state. In some implementations, the digital controller is configured to increment the peak current value when in the first state and decrement the peak current value when in the second state. In some implementations, the second average value is less than the first average value. In some implementations, the digital controller is configured to transition from operating in the first state to operating in the second state when the voltage on the capacitor is greater than the target voltage value, and to transition from operating in the second state to operating in the first state when the voltage across the capacitor is less than the target voltage value.

In some implementations, the digital controller is configured to detect a transient load condition, and in response to detecting a transient load condition, operate in the first state until the output voltage is greater than the target voltage. In some implementations, the digital controller is configured to transition from operating in the second state to operating in the third state upon detection of an over voltage condition across the capacitor. In some implementations, one terminal of the inductor is connected to a DC voltage source, and where the switching circuit includes a switch, one terminal of which is connected to ground, another terminal of which is connected to the other terminal of the inductor, and a control terminal which receives a control signal from the controller, such that in an ON state the switch energizes the inductor from the DC voltage source and in an OFF state, the switch allows the inductor to provide the output current to the capacitor and the display device.

In some implementations, the switching circuit includes an inverter and a switch. An output of the inverter is connected to one terminal of the inductor and an input of the inverter receives an inverter control signal from the controller. One terminal of the switch is connected to the other terminal of the inductor, the second terminal of the switch is connected to ground, and a control terminal of the switch receives a switch control signal from the controller. In an ON state the switch provides a current path to energize the inductor and in the OFF state the switch allows the inductor to provide the output current to the capacitor and the display device.

In some implementations, one terminal of the inductor is connected to ground, and where the switching circuit includes a switch, one terminal of which is connected to a DC voltage source, another terminal of which is connected to the second terminal of the inductor, and the control terminal of which receives a switch control signal from the controller, such that in an ON state, the switch energizes the inductor from the DC voltage source, and in the OFF state the switch allows the inductor to provide the output current to the capacitor and the display device.

In some implementations, the apparatus further includes a display, a processor capable of communicating with the display, the processor being capable of processing image data, and a memory device capable of communicating with the processor. In some implementations, the apparatus further includes a driver circuit capable of sending at least one signal to the display, and a controller capable of sending at least a portion of the image data to the driver circuit. In some implementations, the apparatus further includes an image source module capable of sending the image data to the processor, where the image source module includes at least one of a receiver, transceiver, and transmitter. In some implementations, the apparatus further includes an input device capable of receiving input data and communicating the input data to the processor.

Another innovative aspect of the subject matter described in this disclosure can be implemented in a method for providing an output current to a display device connected in parallel with a capacitor from a switched inductor circuit. The method includes operating a switched inductor circuit to perform a plurality of commutation cycles to provide an output current to a capacitor and a display device connected in parallel to the capacitor, where an average value of the output current during a commutation cycle is in part a function of a peak inductor current value. The method further includes selectively operating in at least one of a first state for a first time period, a second state for a second time period, and a third state for a third time period, where operating in the first state includes performing the plurality of commutation cycles to generate a first average value of the output current, operating in the second state includes performing the plurality of commutation cycles to generate a second average value of the output current, and operating in the third state includes maintaining substantially zero average value of the output current. The method also includes dynamically adjusting the peak current value such that the third time period diminishes over a plurality of iterations of operating through the first, second, and third states, and a voltage across the capacitor converges towards a target voltage.

In some implementations, operating a switched inductor circuit to perform a plurality of commutation cycles includes selectively energizing an inductor and selectively allowing the inductor to provide the output current to the capacitor and to the display device in each of the plurality of commutation cycle. In some implementations, selectively operating in at least one of a first state for a first time period, a second state for a second time period, and a third state for a third time period includes diminishing the third time period to substantially zero over a plurality of iterations through the first state, second state, and the third state. In some implementations, selectively operating in at least one of a first state for a first time period, a second state for a second time period, and a third state for a third time period includes incrementing the peak current value in the first state and decrementing the peak current value in the second state.

In some implementations, selectively operating in at least a first state for a first time period and a second state for a second time period includes transitioning from operating in the first state to operating in the second state when the voltage on the capacitor is greater than the target voltage value, and transitioning from operating in the second state to operating in the first state when the voltage across the capacitor is less than the target voltage value. In some implementations, selectively operating in at least one of a first state for a first time period, a second state for a second time period, and a third state for a third time period includes detecting a transient load condition, and in response to detecting a transient load condition operating in the first state until the output voltage is greater than the target voltage. In some implementations, selectively operating in at least one of a first state for a first time period, a second state for a second time period, and a third state for a third time period includes transitioning from operating in the second state to operating in the third state upon detection of an over voltage condition across the capacitor.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows a block diagram of an example display apparatus.

FIG. 4A shows a block diagram of an example power supply module.

FIG. 4B shows an example VSENSE circuit for implementing the VSENSE module shown in FIG. 4A.

FIGS. 5A and 5B show an example high-voltage booster.

FIGS. 6A and 6B show another example high-voltage booster circuit and corresponding example timing diagrams, respectively.

FIG. 7 shows another example timing diagram associated with operation of the high-voltage booster circuit shown in FIG. 8A.

FIGS. 8A and 8B show an example medium-voltage booster.

FIGS. 9A and 9B show an example negative-voltage booster.

FIG. 10 shows example waveforms of supply current with and without automatic adjustment of the value of IPEAK shown in FIG. 7.

FIG. 11 shows an example state machine diagram executed by a digital controller of a power supply module.

FIG. 12 shows a list of actions carried out by a digital controller in each of the states in the example state machine diagram shown in FIG. 11.

FIG. 13 shows example simulation results of various voltages and currents of a medium-voltage booster executing the state machine and actions shown in FIGS. 11 and 12, respectively.

FIGS. 14A and 14B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A display apparatus can include a power supply module for providing power to various components of the display apparatus. The power supply module can include a DC/DC switched power supply. The power supply module includes a switch that is coupled to an external inductor. The switch is switched ON (for time T_{ON}) to energize the inductor from an external DC power supply, and then switched OFF (for time T_{OFF}) to allow the inductor to supply power to charge a capacitor, and to various components of the display apparatus. The power supply module also includes feedback circuitry such as a voltage sense module for sensing whether the output voltage of the power supply module is less than a target voltage value, and a current sense module for sensing whether the output current is equal to or greater than a peak current value. The power supply module transitions from T_{ON} to T_{OFF} if the output current is equal to or greater than the peak current value, and transitions from T_{OFF} to T_{ON} after the elapse of a timer to complete one switching or commutation cycle. The power supply module executes a number of commutation cycles until the voltage sense module indicates that the output voltage of the power supply module is not less than the target voltage.

In some implementations, the power supply module, at any given time, can operate in one of three states: an active-high state, an active-low state, and a suspend state. In the active-high state and in the active-low state the power supply module executes commutation cycles to provide continuous output current, while in the suspend state the power supply module does not execute any commutation cycles and does not provide an output current. In the active-high state the power supply module increases the peak current value, while in the active-low state the power supply module decreases the peak current value. The power supply module can transition between the three states based, in part, on the output of the voltage sense module. In some implementations, under high current demand, the power supply module minimizes the time spent in the active-low state. As the current demand is being met, the power supply module can reduce the time spent in the suspend state and increases the time spent in the active-high state and the active-low state, resulting in a continuous output current and low output voltage ripple.

Particular implementations of the subject matter described in this disclosure can be implemented to realize one or more of the following potential advantages. Utilizing a switched DC/DC power supply module allows provisioning of power to a display apparatus over a wide range of current loads. In some implementations, the power supply module may have the ability to automatically adjust one or more control parameters such as a peak current value. The automatic adjustment of the peak current value allows the power supply module to operate in continuous conduction mode thereby reducing peak power consumption, reducing switching frequency spectrum width, and improving power efficiency.

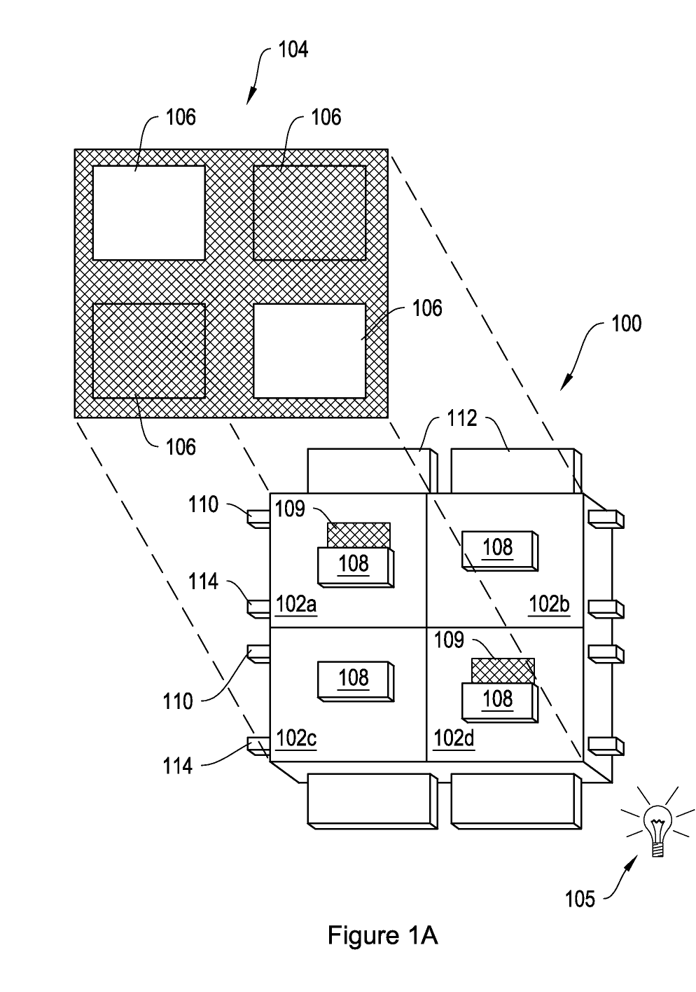

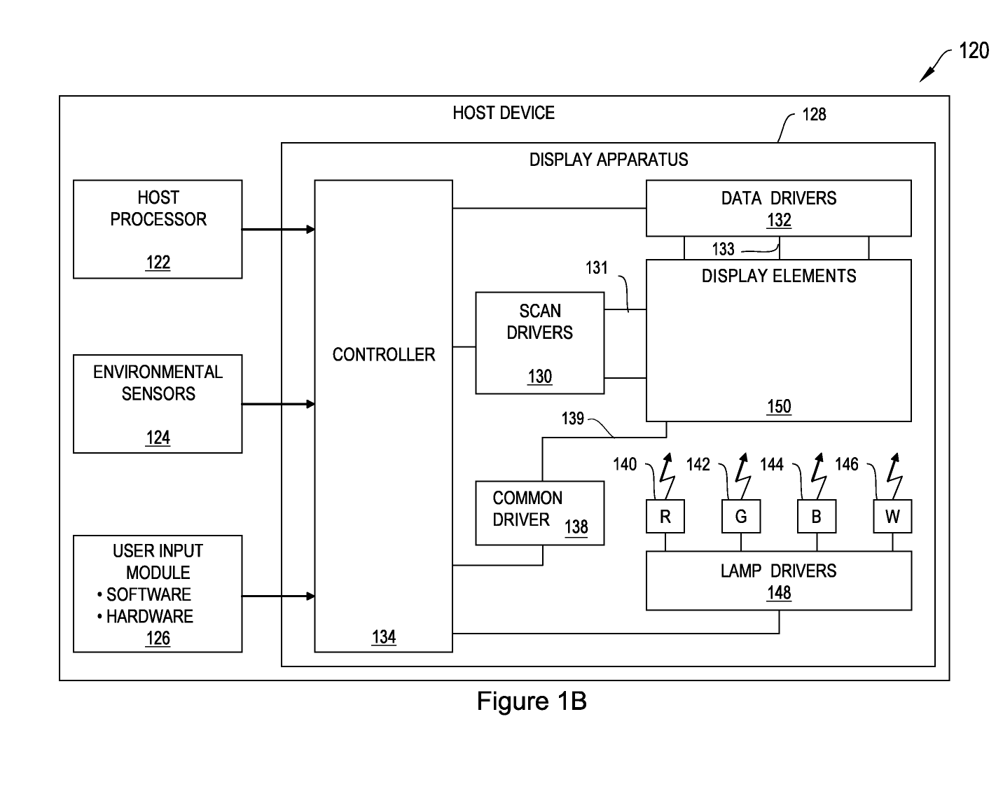

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

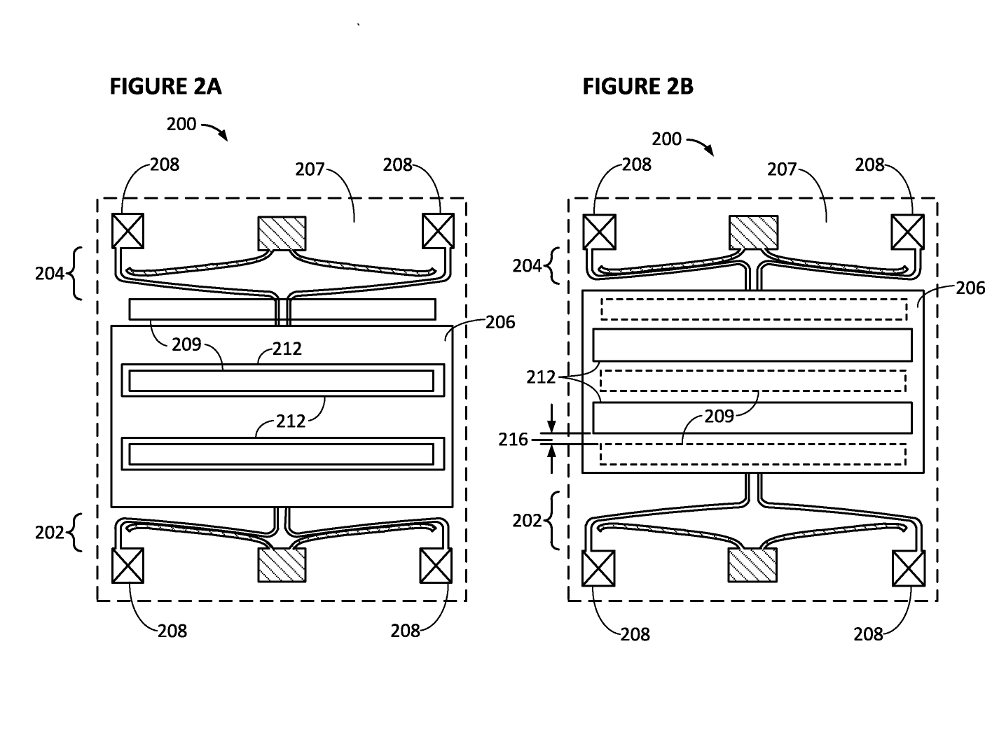

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

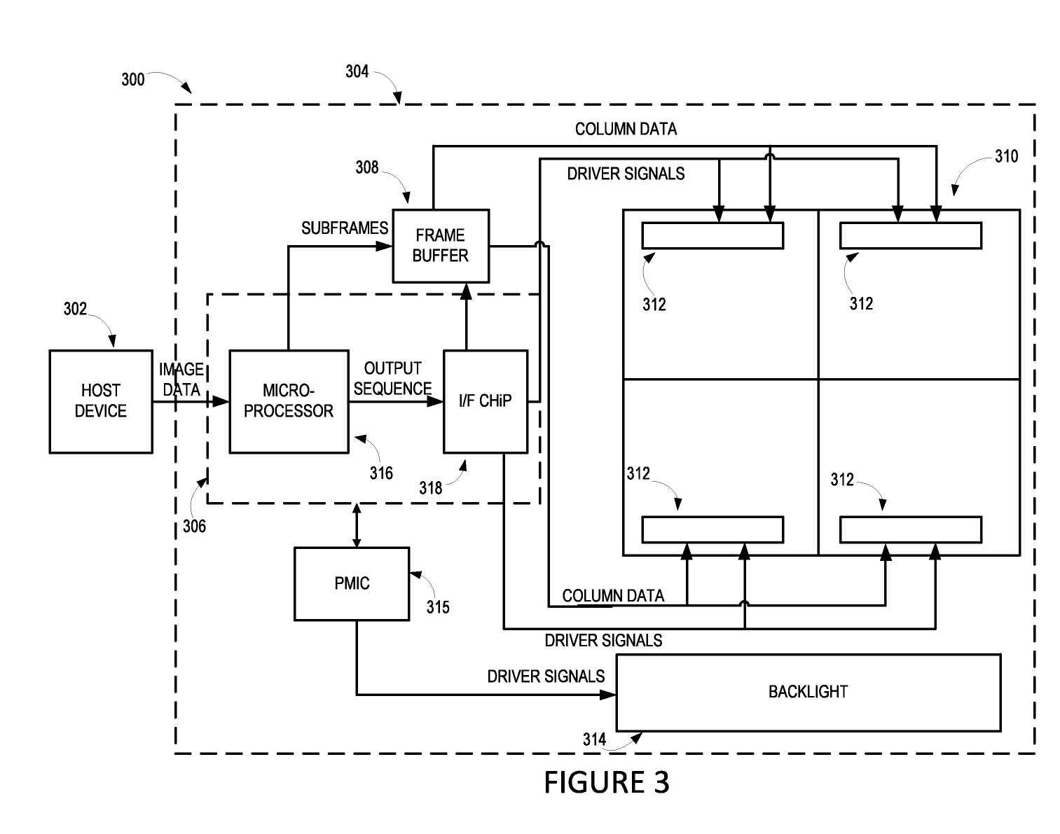

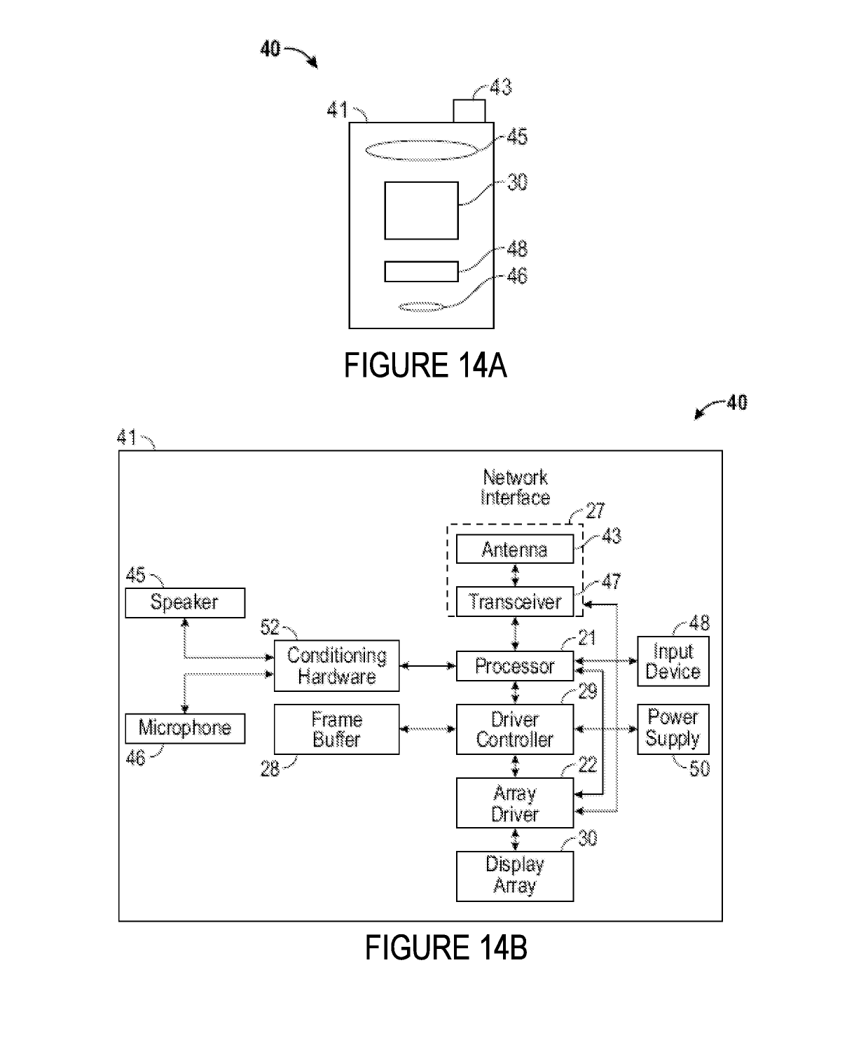

FIG. 3 shows a block diagram of an example display apparatus 300. The display apparatus 300 includes a host device 302 and a display module 304. The host device 302 can be an example of the host device 120 and the display module 304 can be an example of the display apparatus 128, both shown in FIG. 1B. The host device 302 can be any of a number of electronic devices, such as a portable telephone, a smartphone, a watch, a tablet computer, a laptop computer, a desktop computer, a television, a set top box, a DVD or other media player, or any other device that provides graphical output to a display, similar to the display device 40 shown in FIGS. 14A and 14B below. In general, the host device 302 serves as a source for image data to be displayed on the display module 304.

The display module 304 further includes control logic 306, a frame buffer 308, an array of display elements 310, display drivers 312, a backlight 314, and a power management integrated circuit (PMIC) 315. In general, the control logic 306 serves to process image data received from the host device 302 and controls the display drivers 312, array of display elements 310 and backlight 314 to together produce the images encoded in the image data. The control logic 306, frame buffer 308, array of display elements 310, and display drivers 312 shown in FIG. 3 can be similar, in some implementations, to the driver controller 29, frame buffer 28, display array 30, and array drivers 22 shown in FIGS. 14A and 14B, below. In general, the PMIC controls the delivery of power from a battery (not shown) to the display drivers 312 as well as the light sources included in the backlight 314.

In some implementations, as shown in FIG. 3, the functionality of the control logic 306 is divided between a microprocessor 316 and an interface (I/F) chip 318. In some implementations, the interface chip 318 is implemented in an integrated circuit logic device, such as an application specific integrated circuit (ASIC). In some implementations, the microprocessor 316 is configured to carry out all or substantially all of the image processing functionality of the control logic 306. In addition, the microprocessor 316 can be configured to determine an appropriate output sequence for the display module 304 to use to generate received images. For example, the microprocessor 316 can be configured to convert image frames included in the received image data into a set of image subframes. Each image subframe can be associated with a color and a weight, and includes desired states of each of the display elements in the array of display elements 310. The microprocessor 316 also can be configured to determine the number of image subframes to display to produce a given image frame, the order in which the image subframes are to be displayed, timing parameters associated with addressing the display elements in each subframe, and parameters associated with implementing the appropriate weight for each of the image subframes. These parameters may include, in various implementations, the duration for which each of the respective image subframes is to be illuminated and the intensity of such illumination. The collection of these parameters (i.e., the number of subframes, the order and timing of their output, and their weight implementation parameters for each subframe) can be referred to as an “output sequence.”

The interface chip 318 can be capable of carrying out more routine operations of the display module 304. The operations may include retrieving image subframes from the frame buffer 308 and outputting control signals to the display drivers 312 and the backlight 314 in response to the retrieved image subframe and the output sequence determined by the microprocessor 316. In some other implementations, the functionality of the microprocessor 316 and the interface chip 318 are combined into a single logic device, which may take the form of a microprocessor, an ASIC, a field programmable gate array (FPGA) or other programmable logic device. For example, the functionality of the microprocessor 316 and the interface chip 318 can be implemented by a processor 21 shown in FIG. 14B. In some other implementations, the functionality of the microprocessor 316 and the interface chip 318 may be divided in other ways between multiple logic devices, including one or more microprocessors, ASICs, FPGAs, digital signal processors (DSPs) or other logic devices.

The frame buffer 308 can be any volatile or non-volatile integrated circuit memory, such as DRAM, high-speed cache memory, or flash memory (for example, the frame buffer 308 can be similar to the frame buffer 28 shown in FIG. 14B). In some other implementations, the interface chip 318 causes the frame buffer 308 to output data signals directly to the display drivers 312. The frame buffer 308 has sufficient capacity to store color subfield data and subframe data associated with at least one image frame. In some implementations, the frame buffer 308 has sufficient capacity to store color subfield data and subframe data associated with a single image frame. In some other implementations, the frame buffer 308 has sufficient capacity to store color subfield data and subframe data associated with at least two image frames. Such extra memory capacity allows for additional processing by the microprocessor 316 of image data associated with a more recently received image frame while a previously received image frame is being displayed via the array of display elements 310.

In some implementations, the display module 304 includes multiple memory devices. For example, the display module 304 may include one memory device, such as a memory directly associated with the microprocessor 316, for storing subfield data, and the frame buffer 308 is reserved for storage of subframe data.

The array of display elements 310 can include an array of any type of display elements that can be used for image formation. In some implementations, the display elements can be EMS light modulators. In some such implementations, the display elements can be MEMS shutter-based light modulators similar to those shown in FIG. 2A or 2B. In some other implementations, the display elements can be other forms of light modulators, including liquid crystal light modulators, other types of EMS- or MEMS-based light modulators, or light emitters, such as OLED emitters, configured for use with a time division gray scale image formation process.

The display drivers 312 can include a variety of drivers depending on the specific control matrix used to control the display elements in the array of display elements 310. In some implementations, the display drivers 312 include a plurality of scan drivers similar to the scan drivers 130, a plurality of data drivers similar to the data drivers 132, and a set of common drivers similar to the common drivers 138, as shown in FIG. 1B. As described above, the scan drivers output write enabling voltages to rows of display elements, while the data drivers output data signals along columns of display elements. The common drivers output signals to display elements in multiple rows and multiple columns of display elements.

In some implementations, particularly for larger display modules 304, the control matrix used to control the display elements in the array of display elements 310 is segmented into multiple regions. For example, the array of display elements 310 shown in FIG. 3 is segmented into four quadrants. A separate set of display drivers 312 is coupled to each quadrant. Dividing a display into segments in this fashion can reduce the propagation time needed for signals output by the display drivers to reach the furthest display element coupled to a given driver, thereby decreasing the time needed to address the display. Such segmentation also can reduce the power requirements of the drivers employed.

In some implementations, the display elements in the array of display elements can be utilized in a direct-view transmissive display. In direct-view transmissive displays, the display elements, such as EMS light modulators, selectively block light that originates from a backlight, such as the backlight 314, which is illuminated by one or more lamps. Such display elements can be fabricated on transparent substrates, made, for example, from glass. In some implementations, the display drivers 312 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring. For example, in some implementations, the display drivers 312 can be included within the PMIC 315.

The backlight 314 can include a light guide and one or more light sources (such as LEDs). The light sources can include light sources of multiple colors, such as red, green, blue, and in some implementations white. The light sources are driven by components within the PMIC 315, which are capable of driving the light sources to a plurality of discrete light levels to enable illumination gray scale and/or content adaptive backlight control (CABC) in the backlight. In addition, lights of multiple colors can be illuminated simultaneously at various intensity levels to adjust the chromaticities of the component colors used by the display, for example to match a desired color gamut. Lights of multiple colors also can be illuminated to form composite colors. For displays employing red, green, and blue component colors, the display may utilize a composite color white, yellow, cyan, magenta, or any other color formed from a combination of two or more of the component colors.

The light guide distributes the light output by light sources substantially evenly beneath the array of display elements 310. In some other implementations, for example for displays including reflective display elements, the display apparatus 300 can include a front light or other form of lighting instead of a backlight. The illumination of such alternative light sources can likewise be controlled according to illumination gray scale processes that incorporate content adaptive control features. For ease of explanation, the display processes discussed herein are described with respect to the use of a backlight. However, it would be understood by a person of ordinary skill that such processes also may be adapted for use with a front light or other similar form of display lighting.

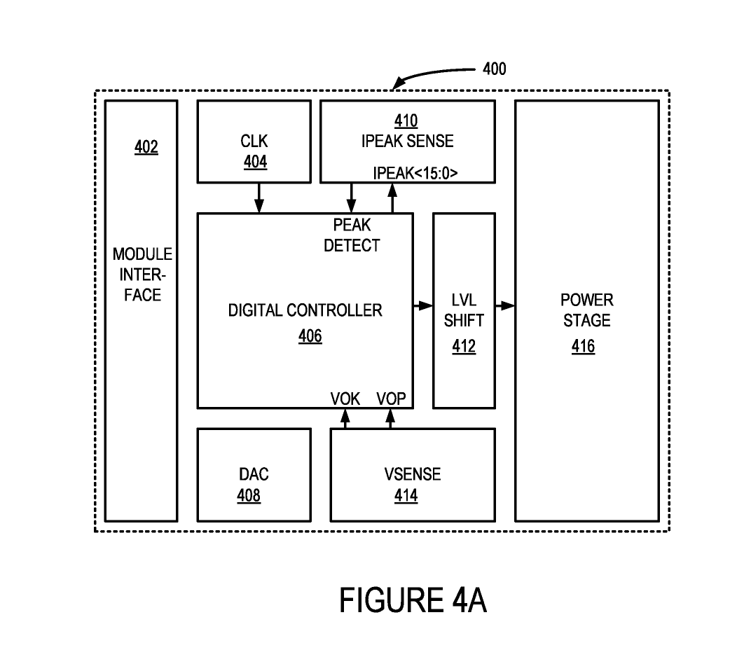

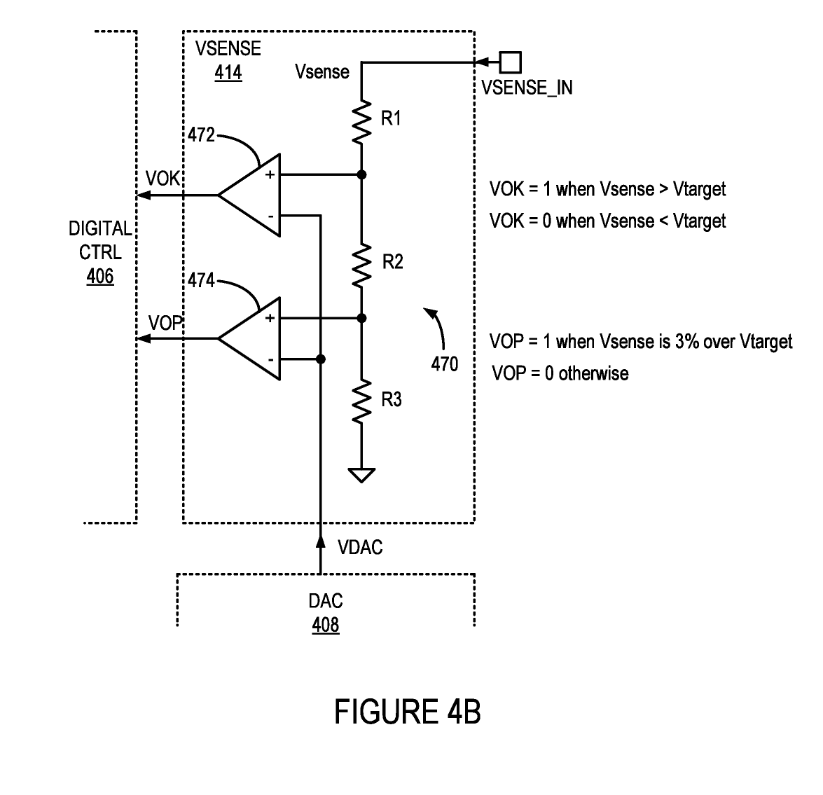

FIG. 4A shows a block diagram of a power supply module 400. In some implementations, the power supply module 400 can be included within the PMIC 315 shown in FIG. 3. The power supply module 400 can include a module interface 402, a clock module 404, a digital controller 406, a digital-to-analog converter (DAC) 408, an IPEAK sense module 410, a level shift module 412, a VSENSE module 414, and a power stage 416. The module interface 402 can be used to communicate with a display controller, such as the control logic 306 shown in FIG. 3. The clock module 404 can generate clock pulses (with example frequency multiplication factors of: 1×, 2×, and 4×) from a system clock and provide the generated clock pulses to the power supply module 400. The digital controller 406 can receive signals from the IPEAK sense module 410 and the VSENSE module 414, and in response, can provide control signals to the level shift module 412, the IPEAK sense module 410, and the power stage 416. The DAC 408 can receive a digital value for a target output voltage Vtarget of the power supply module 400, convert the digital value into an analog voltage VDAC, and provide the analog voltage VDAC to the VSENSE module 414.

The IPEAK sense module 410 can include circuitry to monitor and sense a peak current of an external inductor. In some implementations, the IPEAK sense module 410 may store a value of IPEAK and compare the instantaneous magnitude of the current flowing through the external inductor with the value IPEAK. Based on the comparison, the IPEAK sense module 410 can send signals to the digital controller 406 indicating whether the magnitude of the current flowing through the external inductor is equal to or below IPEAK. The level shift module 412 can receive control voltages from the digital controller 406 and shift the control voltage to levels appropriate for driving various components of the power stage 416. The VSENSE module monitors the state of the output voltage of the power supply module 400, and provides feedback to the digital controller 406. The power stage 416 includes circuitry to control a current provided to the external inductor.

FIG. 4B shows an example VSENSE circuit 470 for implementing the VSENSE module 414 shown in FIG. 4A. The VSENSE circuit 470 can output two signals VOK and VOP to the digital controller 406 based on the sensed output voltage level Vsense received at the VSENSE_IN terminal and the analog DAC voltage VDAC received from the DAC 408 shown in FIG. 4A. The voltage VDAC from the DAC 408 can represent the target output voltage Vtarget of the power supply module 400. In some implementations, the voltage range for Vsense (for example, about 0 to about 25 V) can be substantially greater than the voltage range (for example, about 0 V to about 1 V) of VDAC generated by the DAC 408. In some such implementations, the voltage Vsense can be scaled down using a resistor voltage divider using resistors R1, R2, and R3, as shown in FIG. 4B. The resulting expression for the value of Vtarget can be given by: Vtarget=VDAC×(R2+R3)/(R1+R2+R3). This expression can be utilized to configure the DAC 408 to output the appropriate value for VDAC corresponding to the desired value of Vtarget. A first comparator 472 outputs VOK=1 (indicated by a voltage assigned to logic value ‘1’, such as 5 V) when the Vsense is equal to or greater than Vtarget, otherwise the first comparator outputs VOK=0 (indicated by a voltage assigned to logic value ‘0’, such as 0 V). VOP indicates an over-voltage condition. For example, a second comparator 474 outputs VOP=1 when Vsense is about 3% or more over Vtarget, otherwise the second comparator 474 outputs VOP=0. Percentages other than 3% may be utilized for indicating an over-voltage condition. The two output signals VOK and VOP are provided to the digital controller 406 shown in FIG. 4A.

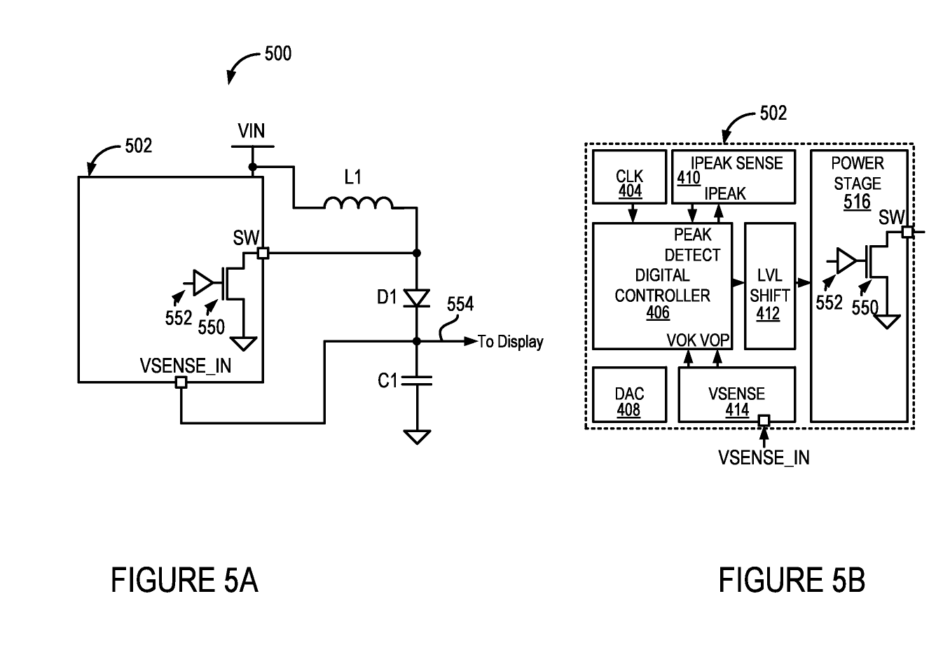

The power supply module 400 can be arranged in various ways with external components to implement a variety of power supply module configurations. One example configuration, a high-voltage booster, is shown in FIGS. 5A and 5B.

As mentioned above, FIGS. 5A and 5B show an example high-voltage booster 500. In particular, FIG. 5A shows a power supply module 502, similar to the power supply module 400 shown in FIG. 4A, connected to external components such as an inductor L1, a diode D1 and a capacitor C1. FIG. 5B shows a block diagram of the power supply module 502 including additional details of a power stage 516. The remaining modules of the power supply module 502 are similar to the corresponding modules in the power supply module 400 discussed above in relation to FIG. 4A.

The power stage 516 includes a transistor switch 550 (such as an n-type metal-oxide semiconductor (NMOS) transistor, an insulated-gate bipolar transistor (IGBT), etc.), a drain terminal of which is coupled to a SW terminal of the power stage and a source terminal of which is coupled to ground. The gate terminal of the transistor switch 550 receives control signals from the digital controller via a driver 552. In some implementations, the driver 552 can be a voltage amplifier or a voltage follower that receives an input from the digital controller 406 and applies the output to the gate terminal of the transistor switch 550. In some implementations, the control signals from the digital controller 406 can be level shifted by the level shift module 412 and then applied to the driver 552. The VSENSE module of the power supply module 502 includes a VSENSE_IN input terminal. The VSENSE module can include circuitry similar to that discussed in relation to FIG. 4B above.

Returning to FIG. 5A, a DC power source VIN provides power to the power supply module 502. The inductor L1 is coupled between the power source VIN and the SW terminal of the power supply module 502. The SW terminal is in turn connected to the drain terminal of the transistor switch 550. The cathode and anode of the diode D1 are coupled to the SW and the VSENSE_IN terminals, respectively, of the power supply module 502. The capacitor C1 is coupled between the VSENSE_IN terminal and ground. An output interconnect 554 is coupled to the cathode terminal of the diode D1 and the capacitor C1 and provides voltage and current generated by the high-voltage booster 500 to various components of the display apparatus.

During operation, the high-voltage booster 500 switches the transistor switch 550 ON to energize the inductor L1. The current flows from the power source VIN, through the inductor L1, via the SW terminal and through the transistor switch 550 to ground. As a result, the inductor L1 is energized form the power source VIN. The transistor switch 550 is maintained in the ON state until the inductor current is equal to a current value IPEAK. The time period for which the transistor switch 550 is maintained in the ON state is denoted by a time period T_{ON}. After the inductor current magnitude is equal to the IPEAK value, the transistor switch 550 is switched OFF for a time period T_{OFF}. As a result, the current flows from the power source VIN, through the inductor L1, via the diode D1 and to the output interconnect 554 to components of the display apparatus and to the capacitor C1. The switching ON followed by switching OFF of the transistor switch 550 constitutes a commutation cycle of period T, where T=T_{ON}+T_{OFF}. The high-voltage booster 500 is operated in repeated commutation cycles to provide the desired voltage and current to the components of the display device.

As mentioned above, the high-voltage booster 500 can be operated in repeated commutation cycles, where each commutation cycle period T is a sum of the time period T_{ON} (during which the external inductor is energized) and time period T_{OFF} (during which the inductor supplies current to the capacitor C1 and the various components of the display apparatus).

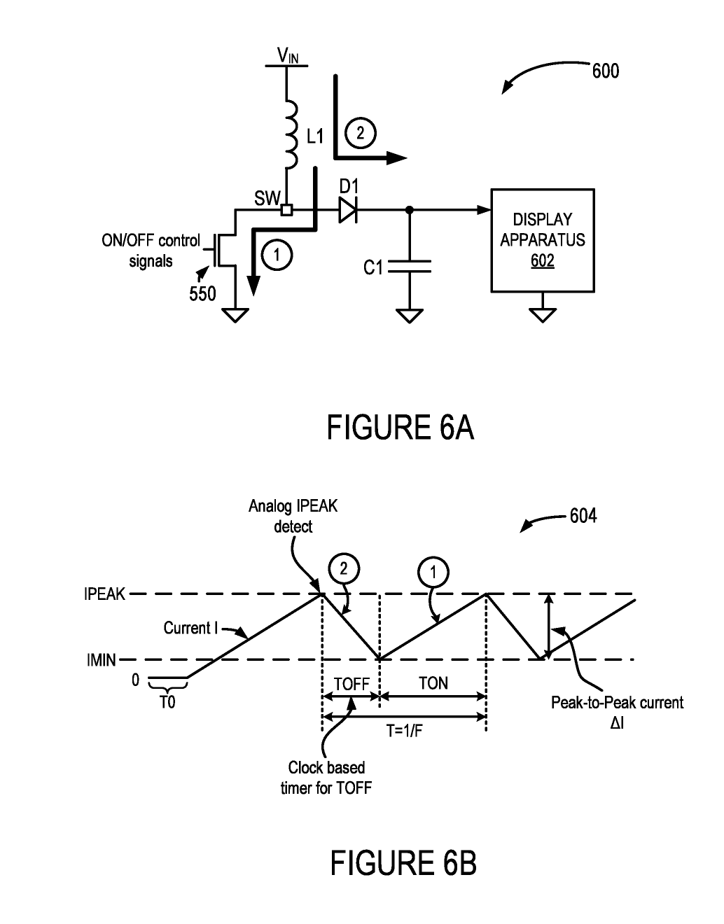

FIGS. 6A and 6B show an example high-voltage booster circuit 600 and corresponding timing diagrams, respectively. In particular, the high-voltage booster circuit 600 schematically represents the high-voltage booster 500 shown in FIG. 5A supplying power to a display apparatus 602. FIG. 6B shows a timing diagram 604 of the current I flowing through the inductor L1. Initially, when the VOK=1, i.e., the output voltage VBOOST is above the target voltage (as discussed above in relation to FIG. 4B), the high-voltage booster circuit 600 is in a suspended state. In the suspended state the transistor switch 550 is in an OFF state, and the current through the inductor is minimal or zero. The suspended state is indicated by time period T0 in FIG. 6B. However, upon demand for power from the display apparatus, the capacitor C1 is discharged, causing the voltage VBOOST to go below the target voltage and resulting in VOK=0.

When VOK=0, the transistor switch 550 is switched ON, resulting in current I to flow from the power source VIN, through the inductor L1, and through the transistor switch 550 to ground (as indicated by the arrow “1” in FIG. 6A). As a result, the current I rises from its initial value of 0. As the current I rises, the IPEAK sense module 410 (shown in FIG. 4A) continuously compares the instantaneous magnitude of the current I with a stored value of IPEAK. When the magnitude of the current I is equal to IPEAK, the IPEAK sense module 410 sends a signal to the digital controller 406 indicating that the magnitude of the current I has reached the value IPEAK. Upon receiving this signal from the IPEAK sense module 410, the digital controller 406 can provide a drive signal that switches the transistor switch 550 into an OFF state.

Upon switching the transistor switch 550 to the OFF state, the high-voltage booster circuit 600 enters a Continuous Conduction Mode (CCM). In the CCM, the high-voltage booster circuit 600 operates in repeated commutation cycles having time period T. Each commutation cycle includes a time T_{OFF} and a time period T_{ON} during which the transistor switch 550 is switched OFF and ON, respectively.

Referring to FIG. 6B, when the transistor switch 550 is switched OFF, the current I in the inductor L1 charges the capacitor C1 and also flows to the various components of the display apparatus (as indicated by the arrow “2” in FIG. 6A), and begins to fall in magnitude from the value IPEAK (as indicated by the label “2” in FIG. 6B). When the transistor switch 550 is switched OFF (i.e., after the inductor current I has reached the value IPEAK), the clock module 404 starts a counter with an initial value that is equivalent to a desired time period T_{OFF}.

After the elapse of time T_{OFF}, the transistor switch 550 is switched ON. This results in the inductor L1 being energized and the inductor current I rising in magnitude (as indicated by the label “1” in FIG. 6B). The inductor current I is again allowed to rise until the magnitude of the inductor current I is equal to the value IPEAK stored in the IPEAK sense module 410. As discussed above, when the magnitude of the inductor current I reaches the value IPEAK, the transistor switch 550 is switched OFF for a time period of T_{OFF}.

The peak-to-peak current (ΔI) during the CCM can be set to a desired magnitude by selecting an appropriate value of T_{OFF}. As shown in FIG. 6B, the magnitude of the inductor current I at the elapse of time period T_{OFF} is IMIN. Thus, the magnitude IMIN is inversely proportional to the time period T_{OFF}. Further, ΔI=IPEAK−IMIN. Therefore, ΔI is directly proportional to the time period T_{OFF}. The following equation represents the relationship between AI and T_{OFF}:

$$Δ I = \frac{( VBOOST - VIN )}{L 1} \cdot {T}_{OFF} \qquad ( Equation 1 )$$

As mentioned above, after the inductor current is equal to the value IPEAK, the transistor switch 550 is again switched OFF for a time period T_{OFF}, restarting the commutation cycle for the commutation time period T. The switching frequency, i.e., the inverse of the commutation time is expressed by the following equation:

$$F = \frac{1}{T} \approx \frac{VIN}{VBOOST} \cdot \frac{1}{{T}_{OFF}} \qquad ( Equation 2 )$$

The commutation cycle is repeated until the demand for power from the display apparatus ceases and the voltage VBOOST is equal to or greater than the target voltage Vtarget (i.e., VOK=1). After VOK=1, the digital controller 406 switches OFF the transistor switch 550 and enters a suspended state similar to that indicated by T0 in FIG. 6B.

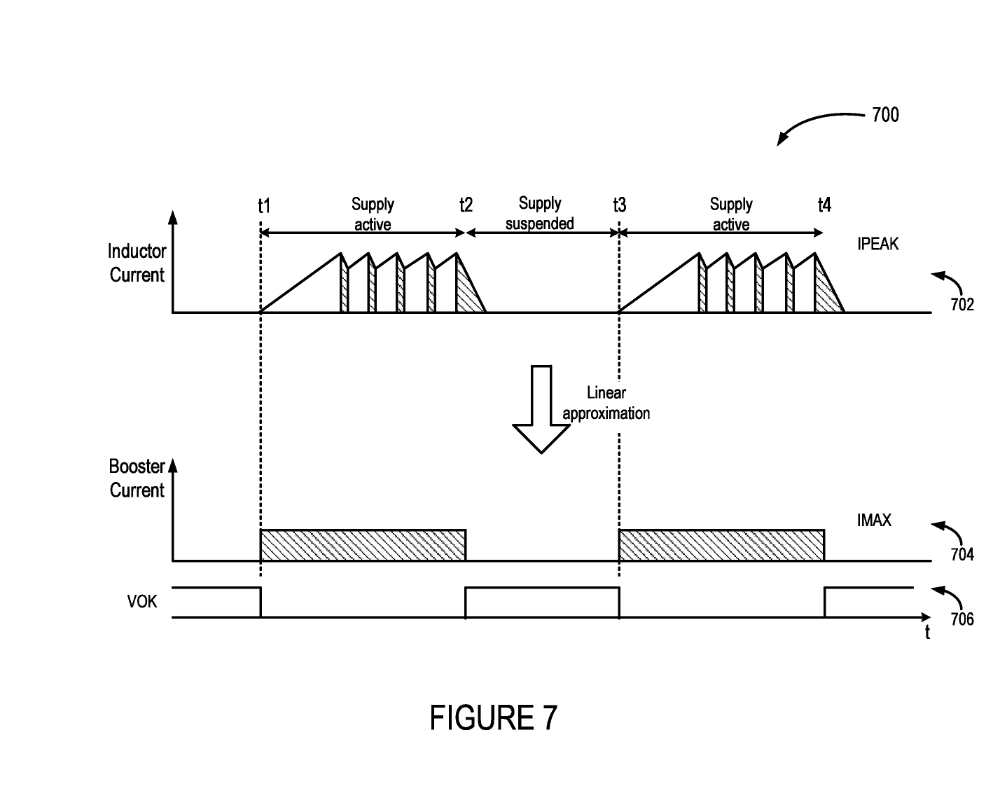

FIG. 7 shows another timing diagram 700 associated with the high-voltage booster circuit 600 shown in FIG. 6A. In particular, the timing diagram 700 shows a waveform of the inductor current I 702, a waveform for the Booster Current 704, representing an average current supplied by the high-voltage booster circuit 600 into the capacitor C1 and to the display apparatus 602, and a waveform representing the state of the output VOK 706 generated by the VSENSE module 414 (shown in FIGS. 4A and 4B). The timing diagram 700 depicts the waveforms of currents and voltages of the high-voltage booster circuit 600 in the “Supply Active” period (between times t1 and t2, and between time t3 and t4) and in the “Supply Suspended” period (prior to time t1, between times t2 and t3, and after time t4).

The high-voltage booster circuit 600 can be in the Supply Active period when the demand for power from the display apparatus rises causing the voltage VBOOST at the output of the high-voltage booster circuit 600 to go below the target voltage Vtarget. That is, the value of VOK=0, as shown in the VOK waveform 706. The inductor current I waveform 702 during the Supply Active period is similar to that depicted in the timing diagram 604 shown in FIG. 6B. That is, the inductor current I rises until its magnitude reaches IPEAK, after which the inductor current enters repeated commutation cycles each cycle having a commutation time period T. As discussed above, the commutation cycle includes a time period TON, during which the inductor L1 is energized, and a time period TOFF during which the inductor L1 provides current to the capacitor C1 and the display apparatus 602. In FIG. 7, the shaded portions of the inductor current I waveform 702 indicate the current provided by the high-voltage booster circuit 600 to the capacitor C1 and the display apparatus 602. The Booster Current waveform 704 shows an average Booster Current (IMAX) provided by the high-voltage booster circuit 600 to the capacitor C1 and to the display apparatus during the Supply Active and the Supply Suspended period. The Booster Current waveform 704 is has been determined using a linear approximation of the shaded portions of the inductor current I waveform 702, however, methods other than the linear approximation method also can be used for determining the average booster current provided by the high-voltage booster circuit 600.

The high-voltage booster circuit 600 is said to enter the Supply Suspended period when the demand for power from the display apparatus ceases, causing the voltage VBOOST at the output of the high-voltage booster circuit 600 to go over the target voltage Vtarget. That is the value of VOK=1, as shown in the waveform 706 in FIG. 7. As discussed above, when VOK=1, the high-voltage booster circuit 600 switches the transistor switch 550 to the OFF state. Thus, substantially no current is drawn from the supply source VIN during the Supply Suspended period. As a result, the booster current, as shown in the waveform 704, is also substantially zero.

The average Booster current (IMAX) can be tuned by selecting an appropriate value for the IPEAK. For example:

$$IMAX ∝ ( IPEAK - \frac{VBOOST - VIN}{2 \cdot L 1} \cdot {T}_{OFF} ) \qquad ( Equation 3 )$$

Thus, an increase in the value of IPEAK stored in the IPEAK sense module 410 (shown in FIG. 4A) would result in a corresponding increase in the magnitude IMAX of the average Booster Current during the Supply Active period of the high-voltage booster circuit 600.

Thus, the stored value of IPEAK can be utilized to adjust the magnitude IMAX of the average Booster Current provided by the high-voltage booster circuit 600 to the capacitor C1 and to the display apparatus.

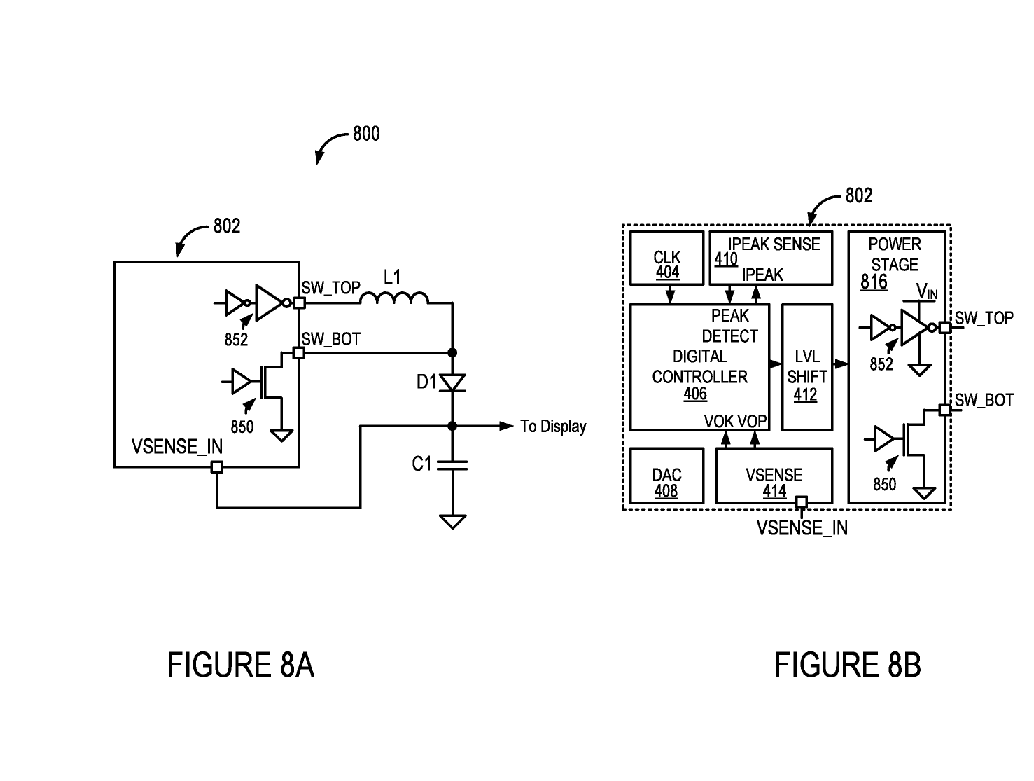

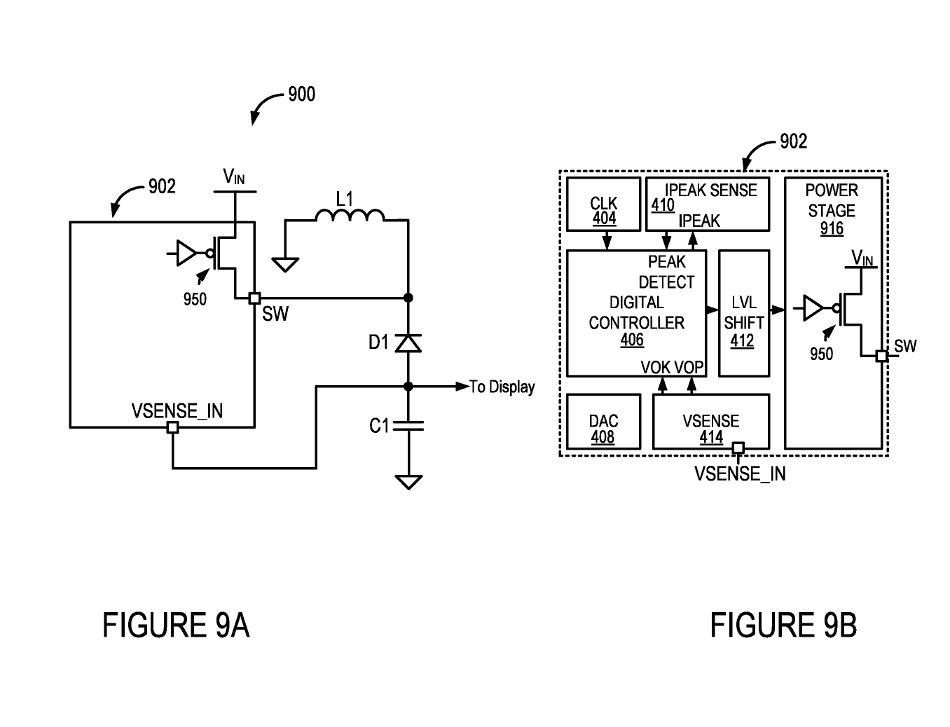

The power supply module 400 shown in FIG. 4 can be arranged in ways other than that discussed in relation to the high-voltage booster circuit 500 shown in FIGS. 5A and 5B. For example, FIGS. 8A and 8B show an example medium-voltage booster circuit 800, while FIGS. 9A and 9B show an example negative-voltage booster circuit 900.

FIG. 8B shows a block diagram of a portion of the power supply module 802 including additional details of a power stage 816. The remainder of the modules of the power supply module 802 are similar to the corresponding modules in the power supply module 400 discussed above in relation to FIG. 4A. The power stage 816 can include a transistor switch 850 similar to the transistor switch 550 shown in FIG. 5B, and an inverter 852.

FIG. 8A shows the medium voltage booster 800 including the power supply module 802 connected to external components such as an inductor L1, a diode D1 and a capacitor C1. During operation, the transistor switch 850 is switched ON and the inverter 852 input is brought low such that the inverter 852 output is high to energize the inductor L1. As a result, the current flows from the power source VIN, through the inverter 852, via the terminal SW_TOP, through the inductor L1, via the terminal SW_BOT, and through the transistor switch 850 to ground. The current flow is maintained until the inductor current reaches a magnitude that is equal to an IPEAK value. The time period for which the current flow is maintained is denoted by a time period T_{ON}. After the elapse of time period T_{ON}, the transistor switch 850 is switched OFF and the input to the inverter is switched high such that the output of the inverter is low for a time period T_{OFF}. As a result, the current flows from the inverter 852 and via the terminal SW_TOP, through the inductor L1, the diode D1 and to the capacitor C1 and the various components of the display device connected to the interconnect VMV. The medium-voltage booster 800 is also operated over repeated commutation cycles, where each commutation cycle has a time period T=T_{ON}+T_{OFF}.

In contrast with the high-voltage booster 500 shown in FIG. 5A, in which the inductor L1 is coupled to the supply source VIN during the time period T_{OFF}, the inductor L1 in the medium-voltage booster 800 is decoupled from the supply source VIN, and instead is connected to ground (via the inverter 852) during the time period T_{OFF}. As a result, the output voltage provided by the medium-voltage booster 800 is relatively smaller in magnitude than that provided by the high-voltage booster 500 shown in FIG. 5A.

In a manner similar to that described above in relation to the high-voltage booster 600 shown in FIGS. 6A and 6B, the values of T_{OFF} and IPEAK can be utilized for tuning the desired peak-to-peak current, switching frequency T, and the average booster current IMAX for the medium-voltage booster 800.

As mentioned above, FIGS. 9A and 9B show a negative-voltage booster 900. FIG. 9B shows a block diagram of the power supply module 902 including additional details of the power stage 916. The remainder of the modules of the power supply module 902 are similar to the corresponding modules in the power supply module 400 discussed above in relation to FIG. 4A. The power stage 916 can include a PMOS transistor switch 950, the drain terminal and the source terminal of which are connected to a SW terminal of the power supply module 902 and the power source VIN, respectively. FIG. 9A shows the negative-voltage booster 900 including the power supply module 902 connected to external components such as an inductor L1, a diode D1, a capacitor C1, and various components of the display device via an interconnect VNEG. In contrast with the high-voltage booster 500 shown in FIG. 5A, in which the inductor L1 is connected between the power source VIN and the SW terminal, the inductor L1 in the negative-voltage booster 900 is connected between ground and the SW terminal.

During operation, the negative-voltage booster 900 can switch the PMOS transistor switch 950 ON, resulting in a current flow from the power source VIN, through the PMOS transistor switch 950, and through the inductor L1 to the ground. The PMOS transistor switch 950 is maintained in the ON state until the magnitude of the inductor current is equal to an IPEAK value. The time period for which the PMOS transistor switch 950 is maintained in the ON state can be denoted by T_{ON}. After the inductor current has reached the IPEAK value, the PMOS transistor switch 950 is switched OFF for a time period T_{OFF}. As a result, the current flows from the interconnect VNEG, through the diode D1 and the inductor L1 to ground. The negative-voltage booster 700 is also operated over repeated commutation cycles, where each commutation cycle has a time period T=T_{ON}+T_{OFF}.

In a manner similar to that described above in relation to the high-voltage booster 600 shown in FIGS. 6A and 6B, the values of T_{OFF} and IPEAK can be utilized for tuning the desired peak-to-peak current, switching frequency T, and the average booster current IMAX for the negative-voltage booster 900.

In some implementations, such as the high-voltage booster circuits shown in FIGS. 5A-5B and FIGS. 6A-6B, the value of IPEAK is manually stored in the IPEAK sense module 410. In some such implementations, the manually stored value of IPEAK may be sub-optimal during periods of low power demand from the display apparatus. The sub-optimal value of IPEAK may, in some implementations, result in higher output voltage VBOOST ripple, wider frequency spectrum, and reduced power efficiency.

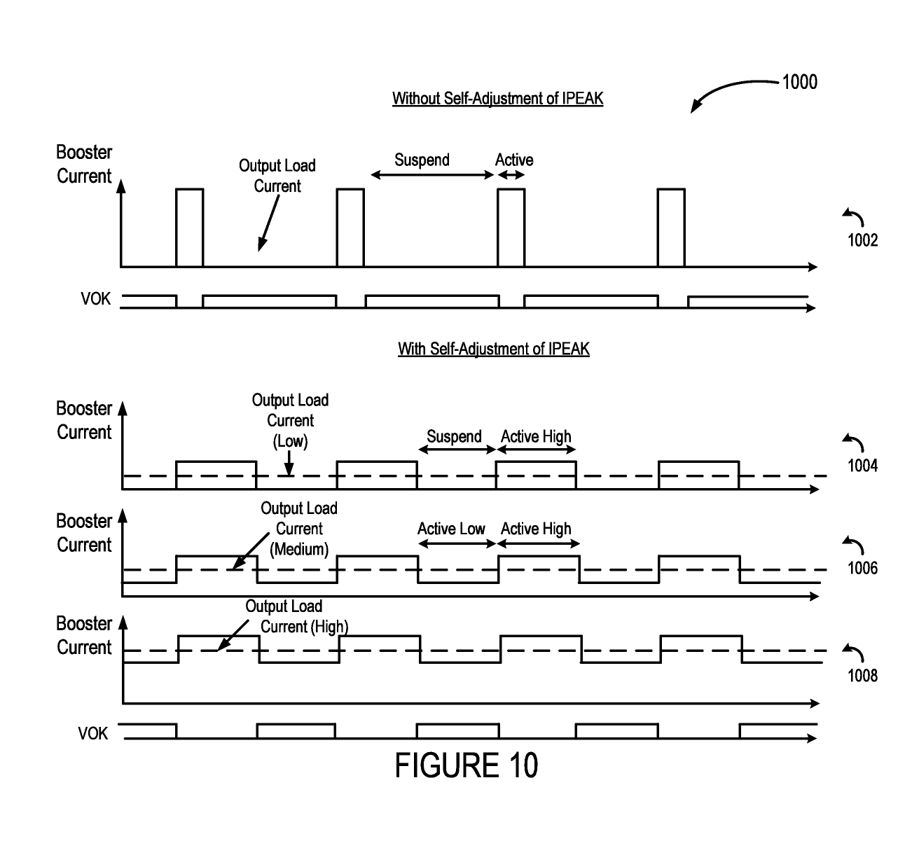

FIG. 10 shows example waveforms 1000 of average Booster Currents with and without automatic adjustment of the value of IPEAK shown in FIG. 7. In particular, waveform 1002 shows the booster current without automatic adjustment of the value of IPEAK, while waveforms 1004, 1006, and 1008 show the booster current with an automatically adjustable value of IPEAK for low, medium, and high output load currents, respectively. As mentioned above in relation to FIGS. 6A, 6B and 7, the booster current is the current provided by the output of the booster circuit, i.e., the current provided to the capacitor C1 and to the display apparatus.

With an automatic adjustment of the value of IPEAK and at lower output load currents, the booster current (the waveform labeled 1004) the value of IPEAK is adjusted to lower IPEAK values relative to the IPEAK value utilized in waveform labeled 1002. The booster current alternates between a SUSPEND mode and an ACTIVE_HIGH mode. The SUSPEND mode indicates that no current is provided by the booster circuit (i.e., when VOK=1) and the ACTIVE_HIGH mode indicates that current is being provided by the booster circuit (i.e., when VOK=0). The lower IPEAK value results in reduced output voltage ripple and reduced switching frequency spectrum. Further power efficiency is improved due to decrease in peak current and decreased power losses in the inductor L1.

The booster current at medium output load currents (the waveform labeled 1006) is continuous and alternates between ACTIVE_HIGH and ACTIVE_LOW modes in contrast with the discontinuous booster current resulting from use of a manually selected IPEAK value (the waveform labeled 1002), and with the discontinuous booster current resulting from the automatically adjusted value of IPEAK at low load currents (the waveform labeled 1004). The continuous and the alternating mode operation of the booster current can be maintained by adjusting the value of IPEAK. During ACTIVE_LOW mode (VOK=1), the value of IPEAK is reduced from that in the ACTIVE_HIGH mode (for example, IPEAK during the active low mode can be half of IPEAK during the ACTIVE_HIGH mode). Thus, the average booster current during the ACTIVE_HIGH mode is greater than the average booster current during the ACTIVE_LOW mode. In comparison with waveforms labeled 1002 and 1004, the switching frequency spectrum for the waveform labeled 1006 is narrower and power efficiency is higher.

The booster current at high output load conditions (the waveform labeled 1008) is similar to the booster current under medium load conditions shown in waveform 1006. However, the IPEAK values are adjusted higher than that for the medium output load to account for the increased load current. The IPEAK values are nonetheless adjusted to levels that allow the booster current to substantially alternate between the ACTIVE_HIGH and the ACTIVE_LOW modes. The waveform labeled 1008 also shows improved switching frequency spectrum and power efficiency in comparison to the frequency spectrum and power efficiency associated with the waveforms labeled 1002 and 1004.

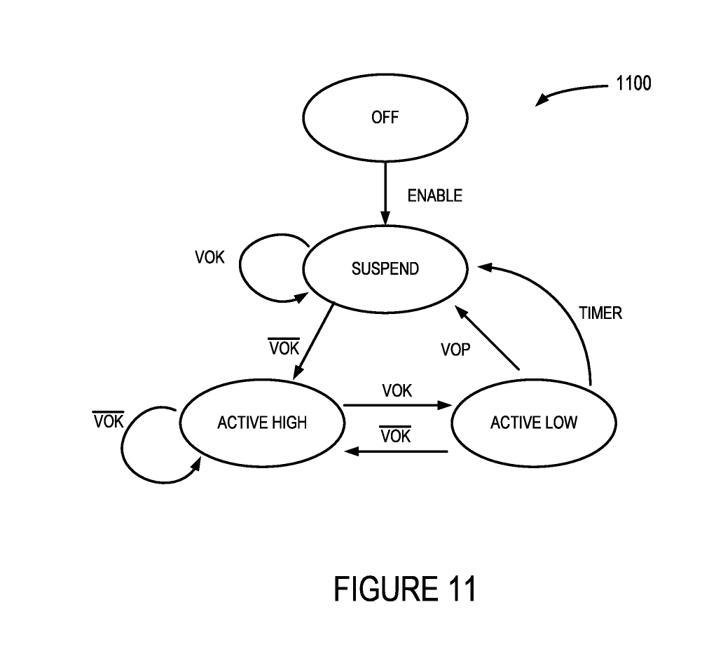

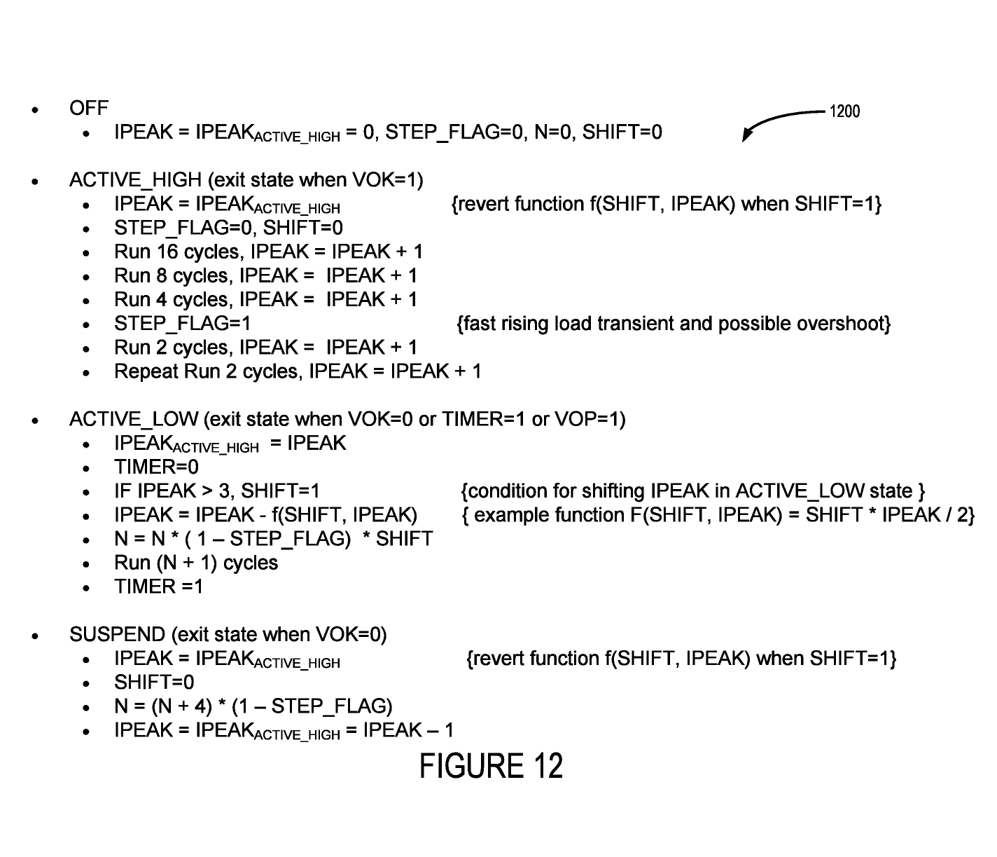

FIG. 11 shows an example state machine diagram 1100 executed by a digital controller of a power supply module. In particular, the state machine diagram 1100 can be executed by the digital controller 406 shown in FIG. 4A. FIG. 12 shows a list of actions 1200 carried out by a digital controller in each of the states shown in FIG. 11. The Booster current waveforms labeled 1004, 1006, and 1008 shown in FIG. 10 can represent booster currents as a result of the execution of the state machine 1100 shown in FIG. 11. The state machine 1100 includes four states, an OFF state, a SUSPEND state, an ACTIVE_HIGH state, and an ACTIVE_LOW state.

In the OFF state, the power supply module is OFF and there is no demand for load current from the display apparatus, and the digital controller maintains the transistor switch (such as the transistor switch 550 shown in FIGS. 5A and 8A) in the OFF state. Further, as shown in FIG. 12, the digital controller sets the value of a variable IPEAK such that IPEAK=0, sets value of a variable STEP_FLAG such that STEP_FLAG=0, and sets the value of a variable N such that N=0, sets the value of a variable SHIFT such that SHIFT=0, and sets the value of variable IPEAK_{ACTIVE}_{_{—}}_{HIGH} such that IPEAK_{ACTIVE}_{_{—}}_{HIGH}=0. The average booster current can be a function of the value of IPEAK (for example, see Equation 3 above). The value of STEP_FLAG can indicate a fast rising load transient or a possible overshoot condition. The value of N can be set to indicate the duration (such as number of clock cycles) for which the digital controller stays within a state. The value of SHIFT can indicate whether the digital controller needs to spend time executing in the ACTIVE_LOW state. For example, in low load conditions, it may be desirable not to have the digital controller execute in the ACTIVE_LOW state and instead proceed into the SUSPEND state. In such cases, SHIFT can be set to 0. However, in medium or high load conditions, it may be desirable to execute the ACTIVE_LOW state normally and reduce the value of IPEAK. For example, SHIFT could be set to 1 if the value of IPEAK exceeds a threshold value (such as IPEAK>3) that indicates a non-low load current condition. The value of IPEAK_{ACTIVE}_{_{—}}_{HIGH} can be utilized for preserving the last value of IPEAK in the ACTIVE_HIGH state. The values of the variables STEP_FLAG, SHIFT, and N can be stored in power supply module memory.

Assuming that the digital controller enters the ACTIVE_HIGH state, the digital controller sets the initial values of the variables STEP_FLAG and SHIFT such that STEP_FLAG=0 and SHIFT=0, and sets the value of IPEAK such that IPEAK=IPEAK_{ACTIVE}_{_{—}}_{HIGH}. By equating the value of IPEAK to IPEAK_{ACTIVE}_{_{—}}_{HIGH} the digital controller restores the value of IPEAK to a value prior to entering the previous ACTIVE_LOW state. The digital controller executes a number of commutation cycles (alternating periods of T_{OFF} and T_{ON}) and after executing a preconfigured number of commutation cycles, the digital controller increments the value of IPEAK, as shown in FIG. 12. While in the ACTIVE_HIGH state, the digital controller monitors the value of VOK, and stays in the ACTIVE_HIGH state as long as VOK=0. If after executing the preconfigured number of commutation cycles the value of VOK is still equal to 0, then the digital controller indicates the detection of a fast rising load transient or a possible overshoot condition by setting the variable STEP_FLAG such that STEP_FLAG=1, and executes an additional number of commutation cycles, further increasing the value of IPEAK. The value of IPEAK is increased and additional commutation cycles are executed until the output voltage exceeds the target voltage, i.e., until VOK=1.

If the value of VOK received from the VSENSE module transitions to VOK=1, the digital controller switches to the ACTIVE_LOW state. In the ACTIVE_LOW state, the digital controller preserves the value of IPEAK that was reached at the end of the ACTIVE_HIGH state by setting IPEAK_{ACTIVE}_{_{—}}_{HIGH} to IPEAK. The digital controller sets the value of a TIMER such that TIMER=0. The digital controller then checks for a low load current condition. In a low current condition, the current will be discontinuous (for example, as shown in waveform 1004 in FIG. 10) and the digital controller alternates between the ACTIVE_HIGH state and the SUSPEND state. As a result, it is not desirable to execute the ACTIVE_LOW state as would be done in medium and high load current conditions. The digital controller checks for a low load condition by determining whether the value of IPEAK is greater than a threshold value (such as IPEAK>3). If IPEAK is not greater than the threshold value, then a low load current condition exists, however, if IPEAK is greater than the threshold value, no low load current condition exists. Under low load conditions, SHIFT is maintained at 0. Therefore, IPEAK is unchanged and N=0. As a result, the digital controller executes a single clock cycle in the ACTIVE_LOW state and moves to the SUSPEND state.

However, if the IPEAK is greater than the threshold, then the digital controller sets SHIFT=1. The digital controller then reduces the value of IPEAK by subtracting the function f(IPEAK, SHIFT) from IPEAK. One example of the function f(IPEAK, SHIFT) can be IPEAK×SHIFT/2. Thus, the value of IPEAK would be reduced by half its previous value. The digital controller then determines the value of N. If STEP_FLAG=1, then a fast transient condition has been previously detected. In a fast transient condition, it is desirable to spend less time in the ACTIVE_LOW state. As a result, N is set 0, and the digital controller exits the ACTIVE_LOW state and enters the SUSPEND state. However, if STEP_FLAG=0 indicating no fast transient condition, then the digital controller maintains the value of N and begins to execute N+1 cycles in the ACTIVE_LOW state. If during the execution of the N+1 cycles VOK=0 (while VOP is not equal to 1), then the digital controller exits the ACTIVE_LOW state and re-enters the ACTIVE_HIGH state. If during the execution of the N+1 cycles VOP=1, then the digital controller exits the ACTIVE_LOW state and enters the SUSPEND state. Otherwise, the digital controller waits until the execution of the N+1 cycles is complete, before setting TIMER=1, exiting the ACTIVE_LOW state, and entering the SUSPEND state.

Thus, in the absence of an overshoot condition (VOP=1), for TIMER=0, and for an appropriate range of values for IPEAK, the digital controller is in either one of the ACTIVE_HIGH and ACTIVE_LOW states. The digital controller switches between these two states continuously either without entering (or entering for a few clock cycles) the SUSPEND state. As a result, the supply current remains continuous, examples of which have been discussed above in relation to waveforms labeled 1006 and 1008 shown in FIG. 10.

In the SUSPEND state, the display controller receives the present value for VOK from a VSENSE module (such as the VSENSE module 414 shown in FIG. 4A). If the value of VOK is 1, i.e., the output voltage is at or above the target voltage, the digital controller stays in the SUSPEND state. In the SUSPEND state, as shown in FIG. 12, the digital controller restores the value of IPEAK by equating IPEAK to IPEAK_{ACTIVE}_{_{—}}_{HIGH}. The digital controller sets the value of variable N such that N=(N+4)×(1−STEP_FLAG). Thus, if STEP_FLAG were set to 1 in a previous ACTIVE_HIGH state due to high transients, N would be maintained at 0. Otherwise, of STEP_FLAG=0, the value of N is increased by a certain number (such as 4). In some other implementations, N can be incremented by other values. The digital controller also resets the value of SHIFT to be equal to 0, and decrements the value of IPEAK such that IPEAK=IPEAK−1.

Upon startup or when responding to high transient load current demand (i.e., with STEP_FLAG=1) the digital controller spends the majority of its execution time in the ACTIVE_HIGH and the SUSPEND states with a minimal or no execution time spent in the ACTIVE_LOW state. This continues until the value of IPEAK is large enough such that the STEP_FLAG=0 and a medium or high load current condition exists (i.e., SHIFT=1). After such a condition is met, the proportion of the total execution time spent by the digital controller in executing the SUSPEND state gradually reduces, while the proportion of the total execution time spent by the digital controller in executing the ACTIVE_LOW state gradually increases. Finally, when IPEAK assumes values within an equilibrium range associated with a given load current demand (and VOP is not equal to 0), the digital controller mainly alternates between the ACTIVE_HIGH and the ACTIVE_LOW states (i.e., in continuous conduction mode).

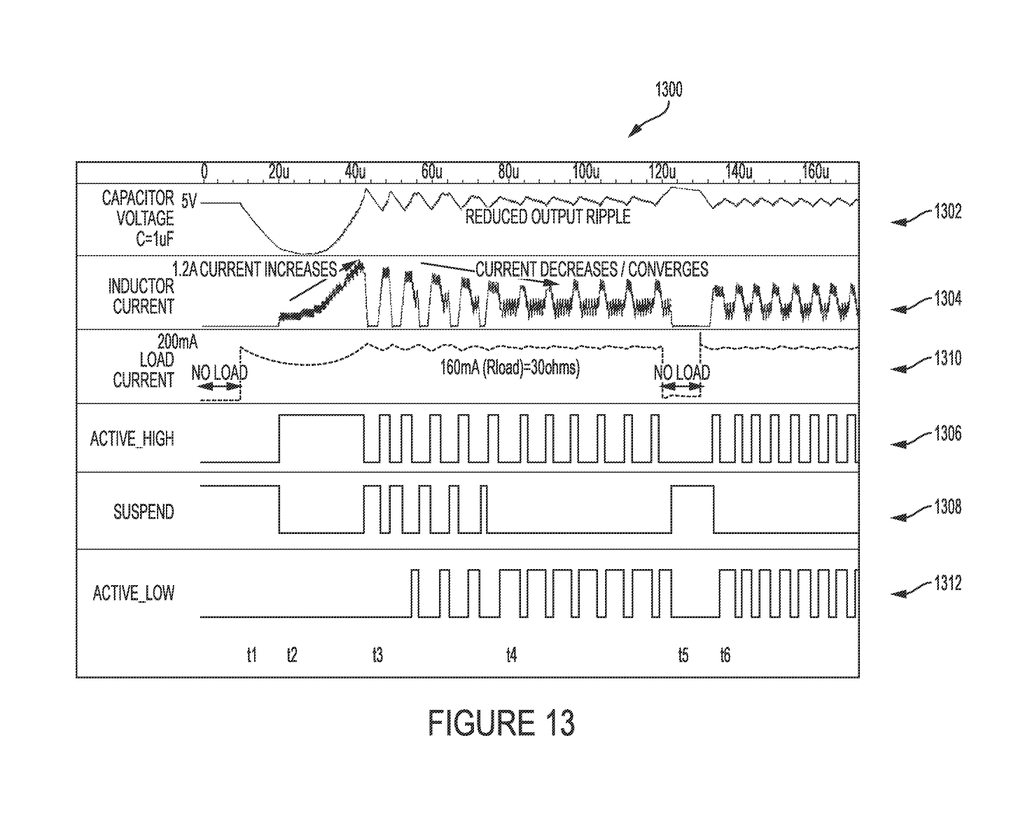

FIG. 13 shows example simulation results 1300 of various voltages, currents, and states of a medium-voltage booster executing the state machine and actions shown in FIGS. 11 and 12. The medium-voltage booster can be represented by, for example, the medium voltage booster 800 shown in FIGS. 8A and 8B. The simulation results 1300 show the automatic adjustment of the value of IPEAK based on a current demand from a display apparatus. The simulation results 1300 include a capacitor voltage waveform 1302, an inductor current waveform 1304, an ACTIVE_HIGH state waveform 1306, a SUSPEND state waveform 1308, a load current waveform 1310, and an ACTIVE_LOW waveform 1312. At time t1, as shown in the load current waveform 1310, the load current increases from a substantially zero value to a non-zero value. In some implementations, the steep increase in the load current demand can result, for example, from an enable event which initially enables the voltage booster to begin supplying power to the load. This demand in load current is initially met by the capacitor C1, which causes the voltage across the capacitor to decrease, as shown in the capacitor voltage waveform 1302. As long as the voltage across the capacitor is above the target voltage Vtarget, the VSENSE module outputs VOK=1, which results in the voltage booster being maintained in the SUSPEND state. Between time t1 and t2, the voltage booster can be maintained in the SUSPEND state for an initialization period, following an enable event, during which various components of the voltage booster can initialize to their steady state operation. At the end of the initialization period at time t2, if the voltage across the capacitor is below the target voltage Vtarget, i.e., the VSENSE module outputs VOK=0, the voltage booster exits the SUSPEND state and enters the ACTIVE_HIGH state, in which the IPEAK value is increased to meet the load current demand. This results in the inductor current to gradually increase, as shown in the inductor current waveform 1310 starting at time t2. An increase in the inductor current also causes the voltage across the capacitor C1 to increase, as shown in the capacitor voltage waveform 1302.

At time t3, after the initial current demand has been met, the voltage booster begins to alternate between ACTIVE_HIGH and SUSPEND states (indicated by substantially zero inductor current) with a minimal or no execution time spent in the ACTIVE_LOW state, as shown in the ACTIVE_LOW waveform 1312. Gradually, the value of IPEAK is decreased causing the voltage booster to decrease the amount of time spent executing in the SUSPEND state and increase the time spent executing in the ACTIVE_LOW state. After time t4, the voltage booster ceases from entering the SUSPEND state at all, as long as the current demand does not change considerably, and alternates between the ACTIVE_HIGH and the ACTIVE_LOW states. This results in the reduced ripple in the capacitor voltage as shown in the capacitor voltage waveform 1302. At time t5, the load current demand changes to zero. This causes the voltage across the capacitor C1 to rise. When the voltage across the capacitor C1 rises above an overshoot threshold value, the VSENSE module outputs VOP=1. This causes the voltage booster to again enter the SUSPEND state. The voltage booster continues to remain the SUSPEND state as long as the current demand does not change, as shown in the SUSPEND state waveform 1308.

Prior to time t6, the current demand rises again, as shown in the load current waveform 1310. This results in the capacitor C1 voltage to decrease. At time t6, the voltage booster again begins alternating between the ACTIVE_HIGH and ACTIVE_LOW states, without entering the SUSPEND state as shown in waveforms 1306, 1308, and 1312. The voltage booster continues to operate in this manner until the load current demand rapidly changes completely ceases.

FIGS. 14A and 14B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 14B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 14A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising
a switching circuit, coupled to an inductor, a capacitor and a display device connected in parallel to the capacitor, configured to perform a plurality of commutation cycles to provide an output current, wherein an average value of the output current during a commutation cycle is in part a function of a peak inductor current value;
a voltage sensor configured to compare a voltage across the capacitor to a target voltage value; and
a digital controller, coupled to the switching circuit and to the voltage sensor, configured to:
receive the target voltage;
selectively operate in at least one of a first state for a first time period, a second state for a second time period, and a third state for a third time period, wherein operating in the first state includes performing the plurality of commutation cycles to generate a first average value of the output current, operating in the second state includes performing the plurality of commutation cycles to generate a second average value of the output current, and operating in the third state results in maintaining a substantially zero average value of the output current, and
for the received target voltage, dynamically adjust the peak inductor current value such that the third time period diminishes over a plurality of iterations through the first, second, and third states, and the voltage across the capacitor converges towards the target voltage.

2. The apparatus of claim 1, wherein each commutation cycle includes selectively energizing the inductor and selectively allowing the inductor to provide the output current to the capacitor and to the display device.

3. The apparatus of claim 1, wherein the digital controller is further configured to diminish the third time period to substantially zero over the plurality of iterations through the first state, second state, and the third state.

4. The apparatus of claim 1, wherein the digital controller is configured to increment the peak inductor current value when in the first state and decrement the peak inductor current value when in the second state.

5. The apparatus of claim 1, wherein the second average value is less than the first average value.

6. The apparatus of claim 1, wherein the digital controller is configured to transition from operating in the first state to operating in the second state when the voltage on the capacitor is greater than the target voltage value, and to transition from operating in the second state to operating in the first state when the voltage across the capacitor is less than the target voltage value.

7. The apparatus of claim 1, wherein the digital controller is configured to detect a transient load condition, and in response to detecting a transient load condition, operate in the first state until the output voltage is greater than the target voltage.

8. The apparatus of claim 1, wherein the digital controller is configured to transition from operating in the second state to operating in the third state upon detection of an over voltage condition across the capacitor.

9. The apparatus of claim 1, wherein one terminal of the inductor is connected to a DC voltage source, and wherein the switching circuit includes:
a switch, one terminal of which is connected to ground, another terminal of which is connected to the other terminal of the inductor, and a control terminal which receives a control signal from the controller, such that in an ON state the switch energizes the inductor from the DC voltage source and in an OFF state, the switch allows the inductor to provide the output current to the capacitor and the display device.

10. The apparatus of claim 1, wherein the switching circuit includes:
an inverter, an output of which is connected to one terminal of the inductor and an input of which receives an inverter control signal from the controller, and
a switch, one terminal of which is connected to the other terminal of the inductor, the second terminal of which is connected to ground, and a control terminal of which receives a switch control signal from the controller,
wherein in an ON state the switch provides a current path to energize the inductor and in the OFF state the switch allows the inductor to provide the output current to the capacitor and the display device.

11. The apparatus of claim 1, wherein one terminal of the inductor is connected to ground, and wherein the switching circuit includes:
a switch, one terminal of which is connected to a DC voltage source, another terminal of which is connected to the second terminal of the inductor, and the control terminal of which receives a switch control signal from the controller, such that in an ON state, the switch energizes the inductor from the DC voltage source, and in the OFF state the switch allows the inductor to provide the output current to the capacitor and the display device.

12. The apparatus of claim 1, further comprising:
a display;
a processor capable of communicating with the display, the processor being capable of processing image data; and
a memory device capable of communicating with the processor.

13. The apparatus of claim 1, further comprising:
a driver circuit capable of sending at least one signal to the display; and
a controller capable of sending at least a portion of the image data to the driver circuit.

14. The apparatus of claim 1, further comprising:
an image source module capable of sending the image data to the processor, wherein the image source module includes at least one of a receiver, transceiver, and transmitter.

15. The apparatus of claim 1, further comprising:
an input device capable of receiving input data and communicating the input data to the processor.

16. A method for providing an output current to a display device connected in parallel with a capacitor from a switched inductor circuit, comprising:
operating a switched inductor circuit to perform a plurality of commutation cycles to provide an output current to a capacitor and a display device connected in parallel to the capacitor, wherein an average value of the output current during a commutation cycle is in part a function of a peak inductor current value;
selectively operating in at least one of a first state for a first time period, a second state for a second time period, and a third state for a third time period, wherein operating in the first state includes performing the plurality of commutation cycles to generate a first average value of the output current, operating in the second state includes performing the plurality of commutation cycles to generate a second average value of the output current, and operating in the third state includes maintaining substantially zero average value of the output current; and
dynamically adjusting the peak inductor current value such that the third time period diminishes over a plurality of iterations of operating through the first, second, and third states, and a voltage across the capacitor converges towards a target voltage.

17. The method of claim 16, wherein operating a switched inductor circuit to perform a plurality of commutation cycles includes selectively energizing an inductor and selectively allowing the inductor to provide the output current to the capacitor and to the display device in each of the plurality of commutation cycle.

18. The method of claim 16, wherein selectively operating in at least one of a first state for a first time period, a second state for a second time period, and a third state for a third time period includes diminishing the third time period to substantially zero over a plurality of iterations through the first state, second state, and the third state.

19. The method of claim 16, wherein selectively operating in at least one of a first state for a first time period, a second state for a second time period, and a third state for a third time period includes incrementing the peak inductor current value in the first state and decrementing the peak inductor current value in the second state.

20. The method of claim 16, wherein selectively operating in at least a first state for a first time period and a second state for a second time period includes transitioning from operating in the first state to operating in the second state when the voltage on the capacitor is greater than the target voltage value, and transitioning from operating in the second state to operating in the first state when the voltage across the capacitor is less than the target voltage value.

21. The method of claim 16, wherein selectively operating in at least one of a first state for a first time period, a second state for a second time period, and a third state for a third time period includes detecting a transient load condition, and in response to detecting a transient load condition operating in the first state until the output voltage is greater than the target voltage.

22. The method of claim 16, wherein selectively operating in at least one of a first state for a first time period, a second state for a second time period, and a third state for a third time period includes transitioning from operating in the second state to operating in the third state upon detection of an over voltage condition across the capacitor.
